(19) United States
(12) Patent Application Publication
(10) Pub. No.: US 2007/0051241 A1
(43) Pub. Date: Mar. 8, 2007

(54) Hydrogen supply system

(76) Inventors: David Alan Boyd, Reading (GB); Virginie Ogrodnik, Reading (GB); Allin Sidney Pratt, Wallingford (GB)

Correspondence Address: RATNERPRESTIA, P O BOX 980, VALLEY FORGE, PA, 19482-0980, US

(21) Appl. No.: 10/566,769

(22) PCT Filed: Jul. 30, 2004
(86) PCT No.: PCT/GB04/03301

§ 371 Date: Aug. 21, 2006

(30) Foreign Application Priority Data
Jul. 31, 2003 (GB) 0317894.4

(51) Int. Cl. H01M 4/00; B01D 53/02

(52) U.S. Cl. 96/108; 429/40

(57) ABSTRACT

A hydrogen supply system (FIG. 1) comprises a first hydrogen storage material (1), which may be an AB₅ type material, and a second hydrogen storage material (2) which may be a MgH₂ type material; wherein the two hydrogen stores are separate. The first hydrogen storage material can be activated to release hydrogen at a lower temperature than can the second hydrogen storage material and at least a proportion of the hydrogen released from the first hydrogen storage material is utilised to activate the second hydrogen storage material. Hydrogen released from the second hydrogen storage material is made available to a hydrogen consumption system (3). The system is particularly suited for use as a mobile hydrogen supply, for example to provide hydrogen to a fuel cell powered vehicle.

This invention relates to a system for the supply of hydrogen, in particular to a system for the supply of hydrogen stored in the form of hydrides.

The problems associated with the storage and supply of hydrogen must be addressed if a functioning hydrogen economy is to be realised. Commonly, hydrogen can be stored as a compressed gas, a cryogenic liquid or in a chemical form such as a metal hydride. A hydrogen store utilising compressed gas or liquid is attractive from the viewpoint of the amount of hydrogen stored as a percentage of the total weight of the store however, both methods have disadvantages. Compressed gas stores have associated safety issues, which are particularly critical in mobile applications, and liquid stores require complex and expensive cryogenic facilities. Chemical storage of hydrogen, in the form of metal hydrides, does not have the safety problems associated with gaseous stores nor the technical requirements associated with liquid stores, so although, in terms of some measures used for hydrogen storage, e.g. kg per kg store weight, metal hydride stores compare poorly with gas and liquid stores, they are favoured for mobile applications.

Magnesium hydride, MgH₂, contains 7.6 wt % hydrogen, theoretically making it the most promising of all the known reversible hydrides for hydrogen storage applications. However, in order to transfer hydrogen at a reasonable rate, MgH₂ must be heated to around 300° C. It is known to modify the hydride by adding other elements such as nickel and/or platinum group metals, which decreases the hydrogen transfer temperature (particularly the adsorption temperature) however, this can compromise the storage capacity and still requires temperatures well in excess of ambient. Thus, despite modifications to alloy chemistry and physical forms, an additional source of heat is required to produce a functioning hydrogen supply system. This is particularly true during start-up when energy from stored hydrogen is not available.

Other metal hydrides are known which release hydrogen at much lower temperatures. For example, some hydrides of AB₅, AB₂ and AB alloys may release hydrogen at room temperature and below. The storage capacity of these hydrides is however low, with the best storing less than 2% hydrogen by weight. This would make the size and weight of any useful hydrogen store prohibitively large.

The present applicants have combined the benefits of different hydride materials in a single hydrogen supply system.

Thus, in accordance with the present invention, a hydrogen supply system comprises a first hydrogen storage material and a second hydrogen storage material, wherein the two hydrogen stores are separate; and wherein the first hydrogen storage material can be activated to release hydrogen at a lower temperature than can the second hydrogen storage material; wherein at least a proportion of the hydrogen released from the first hydrogen storage material is utilised to activate the second hydrogen storage material; and wherein at least a proportion of the hydrogen released from the second hydrogen storage material is made available to a hydrogen consumption system.

The first hydrogen storage material may be activated to release hydrogen at a temperature of less than 100° C., preferably at a temperature of less than 70° C. or more preferably at a temperature of 30° C. The second hydrogen storage material may be activated to release hydrogen at a temperature of from 250° C. to 350° C.

The first hydrogen storage material has the advantage that it is more readily activated than the second material, which enables more rapid start-up of the system. The second hydrogen storage material may have the advantage that it has a higher storage capacity than the first, so providing a greater amount of hydrogen for a given weight and volume.

The second hydrogen storage material may be activated by oxidising some or all of the hydrogen released from the first material. Conveniently, the hydrogen is combusted to provide heat to the second hydrogen storage material. Alternatively, the hydrogen may be catalytically burnt. This raises the temperature of the second material, activating it and allowing it to release its own stored hydrogen. Preferably, not all of the hydrogen released by the first material is used to activate the second material, but a proportion of it is made available to the hydrogen consumption system. This prevents any delay on start-up by ensuring that the consumption system always has a source of hydrogen available.

It is desirable that the total hydrogen capacity of the second hydrogen storage material is greater than that of the first material. Commonly, the amount of hydrogen stored in the second material will be at least twice, more commonly ten times, perhaps 100 times more than the amount stored in the first material.

In a preferred embodiment, a proportion of the hydrogen released from the second hydrogen storage material is used to recharge the first material. This prevents the first material from becoming exhausted and ensures that the system can be rapidly restarted after it has been shut down.

Although during normal operation, that is after start-up, it is envisaged that most if not all of the hydrogen consumed by the hydrogen consumption system will be provided by the second hydrogen storage material, it is desirable that the facility remains for providing hydrogen also from the first material. In general, the first material will release hydrogen at a faster rate than the second material, so it is able to supplement the hydrogen supply to the consumption system in response to peak energy consumption requirements.

The system may further comprise additional heat sources to provide heat to either or both of the first and second hydrogen storage materials. The hydrogen released, especially that released by the second hydrogen storage material, may be hot. The system may thus include heat exchangers to cool the released hydrogen before it is provided to the hydrogen consumption system. The heat removed may be recycled to the system and used to provide heat to either or both of the first and second hydrogen storage materials.

Preferably, the first hydrogen storage material comprises an AB₅, AB₂ or an AB type material. Some non-limiting examples include, LaNi₅, Al doped LaNi₅, CeNi₅, Al doped CeNi₅, CaNi₅, Mn doped CaNi₅, TiVMn, Zr doped TiCrMn, Zr doped TiCr₂, Co doped TiV₂, Fe/Ti, Ti/Zr, Ti(MnV) and Ti(MnCr). Preferably, the first hydrogen storage material will have a plateau pressure of between 0.1 and 10 bar at room temperature. Materials described in EP 0 979 532 are particularly suitable. Alternative materials will be known to those skilled in the art.

Preferably, the second hydrogen storage material comprises Mg. The second hydrogen storage material may be MgH₂ or MgH₂/Ni or any combination thereof. MgH₂ materials may also be modified with low levels of other metal additions (e.g. 1 wt % Ni); preferably the second hydrogen storage material comprises platinum group metal (PGM). These materials can be formed through milling or mechanical alloying or through melting operations as is known in the art. Alternative materials will be known to those skilled in the art.

The hydrogen consumption system may be a fuel cell, an internal combustion engine or any other system which requires hydrogen. Preferably, the hydrogen consumption system is a fuel cell. The combination of a hydrogen supply system according to the present invention and a fuel cell provides an electrical power source. Such a source may be static, but is especially suitable as a portable power source. This portability may be exploited to provide electrical power in perhaps a remote area or more preferably, the power source may be used to fully or partially provide motive power to a vehicle.

Thus in a further aspect, the present invention provides a powered vehicle comprising a power source as hereinbefore described. In an alternative embodiment, the vehicle may be powered by an internal combustion engine wherein hydrogen produced by a hydrogen supply system according to the present invention is used at least partially as a fuel. Hybrid fuel cell powered and internal combustion powered vehicles are also envisaged.

The features of the hydrogen supply system according to the present invention are particularly advantageous when applied to powered vehicles. The use of an easily activated first hydrogen storage material allows rapid start-up, which would not be possible using for example, a sole MgH₂ store. Furthermore, the rapid response of the first hydrogen storage material can be utilised when a power boost is required, for example in response to acceleration or under heavy load. It is envisaged that the first hydrogen storage material would be arranged to be responsive to a ‘throttle’ mechanism. The high capacity of the second hydrogen storage material would give a vehicle a reasonable range between refueling stops whilst also minimising weight. It would also be possible to include a regenerative braking system into the vehicle to recoup some of the lost energy normally dissipated as frictional heat. This energy could be used directly to provide additional heat to either or both of the hydrogen storage materials and/or be stored, perhaps in an accumulator, for later use or to power ancillary systems.

Ideally, the power sources described hereinabove would completely replace the petrol and diesel powered internal combustion engines normally used in vehicles. This would lead to significant benefits in terms of environmental pollution levels. Alternatively, the power sources could be used in combination with normal engines. Pollution levels could again be reduced if such vehicles were configured to use the hydrogen power sources in urban areas where environmental concerns are more acute, switching to conventional power in less urban areas. Combination hydrogen/petrol or diesel powered vehicles may also have extended ranges.

According to another aspect, the invention provides a method of activating a second hydrogen storage material for supplying a hydrogen consumption system, which method comprising utilising at least a proportion of a stream of hydrogen generated by activating a separate first hydrogen storage material.

The invention will now be described by way of example only and with reference to the following drawings in which:

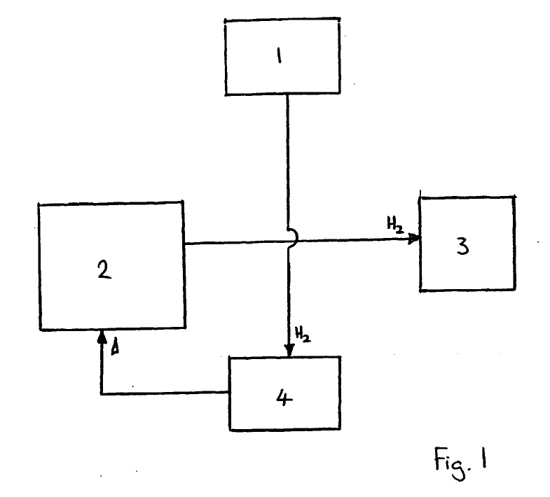

FIG. 1 is a schematic diagram of a first example of a hydrogen supply system according to the present invention,

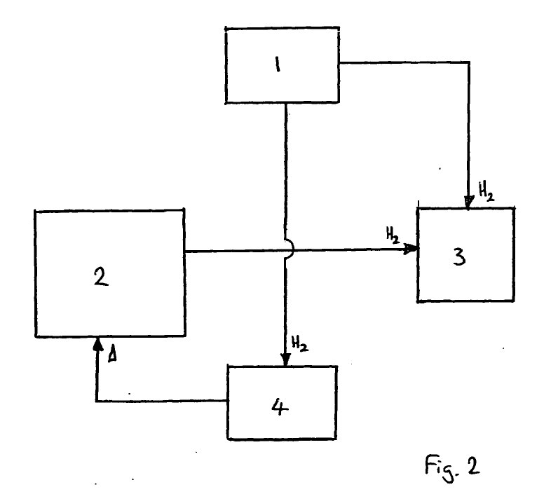

FIG. 2 is a schematic diagram of a second example of a hydrogen supply system according to the present invention,

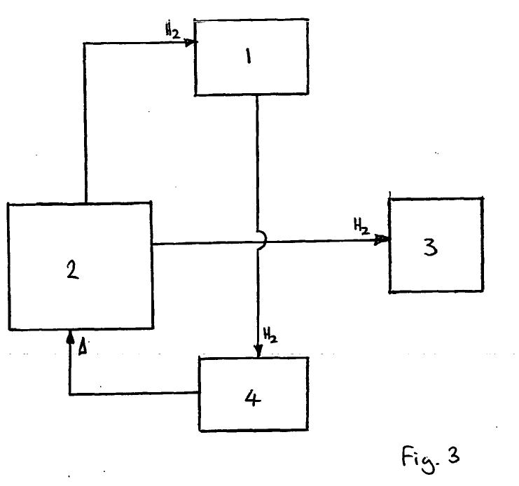

FIG. 3 is a schematic diagram of a third example of a hydrogen supply system according to the present invention,

FIG. 4 is a schematic diagram of a fourth example of a hydrogen supply system according to the present invention,

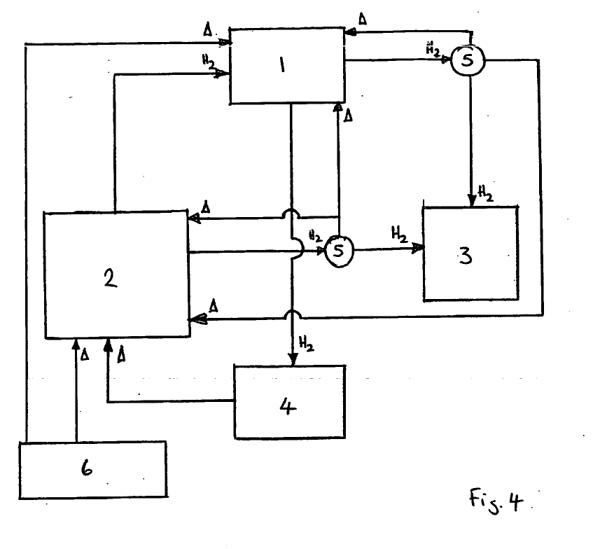

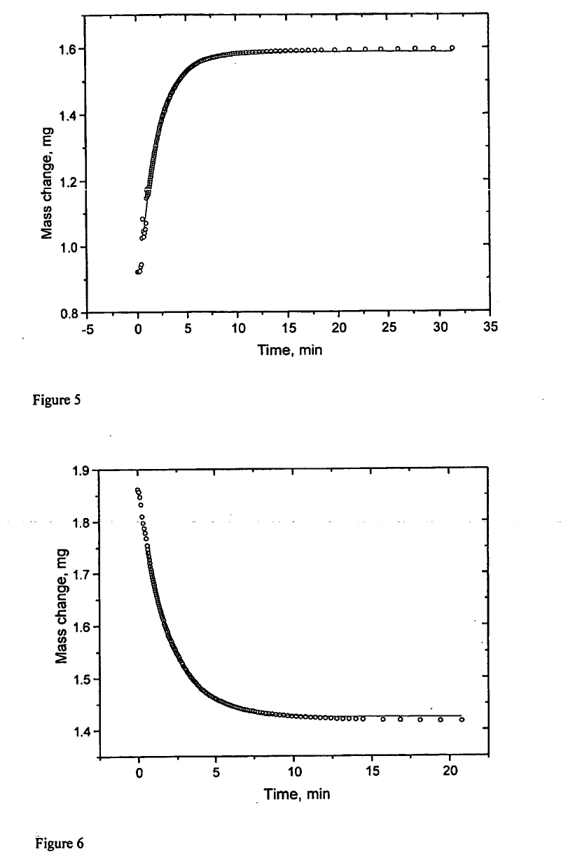

FIG. 5 is a graph showing hydrogen absorption for the Ca_{0.7}Mn_{0.3}Ni₅ material following a 2.3-3.5 bars pressure change at 38° C.,

FIG. 6 is a graph showing hydrogen absorption for the Ca_{0.7}Mn_{0.3}Ni₅ material following a 3.5-2.7 bars pressure change at 38° C.,

FIG. 7 is a graph showing absorption isotherms for LaNi_{4.7}Al_{0.3} at temperatures ranging from 27 to 50° C.,

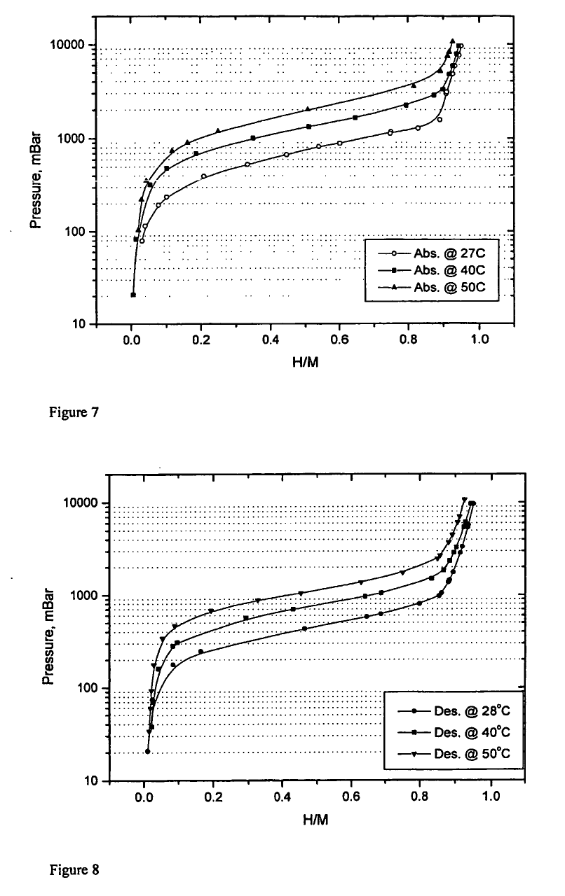

FIG. 8 is a graph showing desorption isotherms for the LaNi_{4.7}Al_{0.3} at temperatures ranging from 28 to 50° C.,

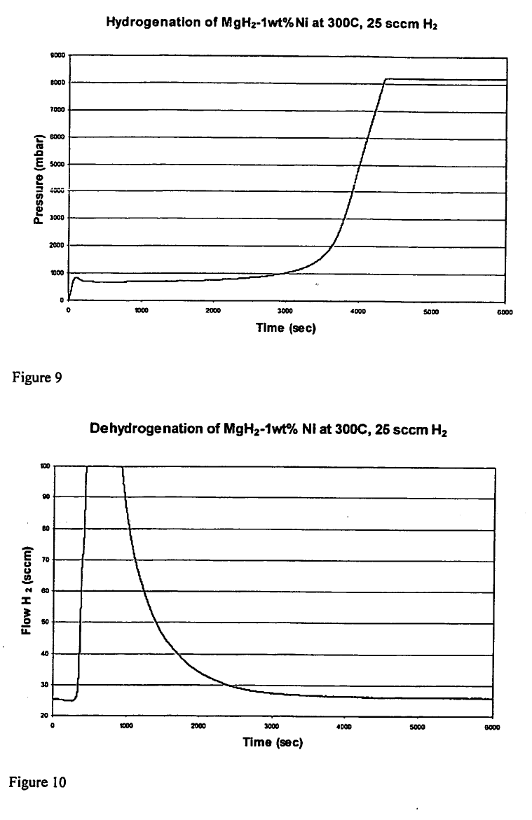

FIG. 9 is a graph showing hydrogen absorption for the MgH₂ 1 wt % Ni material at 300° C.; and,

FIG. 10 is a graph showing hydrogen desorption for the MgH₂ 1 wt % Ni material at 300° C.

With reference to FIG. 1, a hydrogen supply system comprises an AB₅ hydride store 1, a MgH₂ store 2, a hydrogen consumption system 3 and a hydrogen burner unit 4. Hydrogen released from the AB₅ hydride store is passed to the burner unit where it is combusted. The AB₅ store is able to release hydrogen at ambient temperature, so usually no additional heat source is required, although one can of course be provided if necessary. The heat evolved by the burning hydrogen (Δ indicates the flow of heat in FIGS. 1-4) is used to provide heat to the MgH₂ store. Once the MgH₂ store has reached a sufficiently high temperature (e.g. 300° C.), it begins to release hydrogen. This hydrogen is then provided to the hydrogen consumption unit.

The system of FIG. 1 has the drawback that there is a delay before any hydrogen is available to the hydrogen consumption system. An improved system is shown in FIG. 2. In this system, a proportion of the hydrogen released from the AB₅ store 1 is made available to the hydrogen consumption system 3. Once the MgH₂ store has been activated as described with reference to the system of FIG. 1, the supply of hydrogen from the AB₅ store to the hydrogen consumption system can be stopped. Alternatively, the consumption system may continue to be provided with hydrogen by both stores, or only by both under peak consumption conditions.

A further modification is shown in FIG. 3. Here, some of the hydrogen released by the MgH₂ store 2 is used to recharge the AB₅ store 1.

A system incorporating ether optional aspects of the invention is shown in FIG. 4. This system is particularly suitable for use in a vehicle (as are the systems of FIGS. 1 to 3). The features of the systems of FIGS. 1 to 3 are incorporated as well as heat exchangers 5 and a regenerative braking system 6. The heat exchanger 5 between the MgH₂ store 2 and the hydrogen consumption system 3 is more important than that which is between the AB₅ store 1 and the consumption system. This is because the hydrogen released from the MgH₂ store is much hotter than the hydrogen released from the AB₅ store. More heat is thus recoverable from the MgH₂ heat exchanger. Furthermore, particularly in the case where the hydrogen consumption system is a fuel cell, it may be important to cool the hydrogen before it is consumed. Typically, polymer electrolyte membrane fuel cells operate at temperatures of around 80° C. The regenerative braking system 6 recovers heat lost through friction as the vehicle brakes. This heat can be recycled to either or both of the hydrogen stores 1, 2.

1. A hydrogen supply system, the system comprising a first hydrogen storage material and a second hydrogen storage material, wherein the two hydrogen stores are separate; and wherein the first hydrogen storage material can be activated to release hydrogen at a lower temperature than can the second hydrogen storage material; wherein at least a proportion of the hydrogen released from the first hydrogen storage material is utilised to activate the second hydrogen storage material; and wherein at least a proportion of the hydrogen released from the second hydrogen storage material is made available to a hydrogen consumption system, and wherein the second hydrogen storage material is activated by oxidising a proportion of the hydrogen released from the first hydrogen storage material in a hydrogen burner unit.

2. A system according to claim 1, wherein a proportion of the hydrogen released from the first hydrogen storage material is made available to the hydrogen consumption system.

3. A system according to claim 1, wherein a proportion of the hydrogen released from the second hydrogen storage material is used to recharge the first hydrogen storage material.

4. A system according to claim 1, wherein the first hydrogen storage material can be activated to release hydrogen at a temperature of less than 100° C.

5. A system according to claim 1, wherein the second hydrogen storage material can be activated to release hydrogen at a temperature of from 250° C. to 350° C.

6. A system according to claim 1 further comprising one or more heat exchangers to remove heat from the hydrogen released from the first or second hydrogen storage materials.

7. A system according to claim 1, wherein the first hydrogen storage material is selected from the group consisting of an AB₅, an AB₂ and an AB type material, and any combination thereof.

8. A system according to claim 7, wherein the first hydrogen storage material is selected from the group consisting of LaNi₅, Al doped LaNi₅, CeNi₅, Al doped CeNi₅, CaNi₅, Mn doped CaNi₅, TiVMn, Zr doped TiCrMn, Zr doped TiCr₂, Co doped TiV₂, Fe/Ti, Ti/Zr, Ti(MnV) and Ti(MnCr), and any combination thereof.

9. A system according to claim 1, wherein the second hydrogen storage material comprises Mg.

10. A system according to claim 9, wherein the second hydrogen storage material further comprises PGM.

11. A system according to claim 9, wherein the second hydrogen storage material is MgH₂ or Mg H₂/Ni, or any combination thereof.

12. A system according to claim 1, wherein the hydrogen consumption system comprises a fuel cell.

13. A system according to claims 1, wherein the hydrogen consumption system comprises an internal combustion engine.

14. A vehicle, the vehicle comprising a system according to claim 12 as a power source.

15. A method of activating a second hydrogen storage material for supplying a hydrogen consumption system, which method comprising utilising at least a proportion of a stream of hydrogen generated by activating a separate first hydrogen storage material.
